(19) United States
(12) Patent Application Publication
(10) Pub. No.: US 2024/0291656 A1
(43) Pub. Date: Aug. 29, 2024

(54) AUTHENTICATION

(71) Applicant: Hewlett-Packard Development Company, L.P., Spring, TX (US)

(72) Inventors: THALIA MAY LAING, BRISTOL (GB); MARK RYAN, BIRMINGHAM WEST MIDLANDS (GB); YONG QI WANG, BIRMINGHAM WEST MIDLANDS (GB)

(73) Assignee: Hewlett-Packard Development Company, L.P., Spring, TX (US)

(21) Appl. No.: 18/571,640

(22) PCT Filed: Aug. 27, 2021
(86) PCT No.: PCT/US2021/047990

§ 371 Date: Dec. 18, 2023

(51) Int. Cl. H04L 9/32; H04L 9/30

(52) U.S. Cl. CPC H04L 9/321; H04L 9/3073

(57) ABSTRACT

Examples provide machine readable storage storing instructions arranged, when processed, to facilitate authentication using an authenticator, the instructions comprising instructions to generate, by an initial authenticator, authentication data associated with a further authenticator; the authentication data comprising private data and a public credential; the public credential and private data being for use in producing authentication information to authenticate the further authenticator to a relying party; and send data derived from the authentication data to network storage commonly accessible by the initial authenticator and the further authenticator.

### BACKGROUND

Authentication of a user via an authentication device is becoming more frequent. This type of authentication is authentication based on ‘what you have’ as opposed to authentication using ‘what you know’, which may rely on passwords.

### BRIEF INTRODUCTION OF THE DRAWINGS

Examples will be described with reference to the accompanying drawings in which:

FIG. 1 shows an authenticator;

FIG. 2 illustrates a relying party;

FIG. 3 depicts signalling during an introduction phase of authentication;

FIG. 4 shows signalling for registering initial authentication information with the relying party;

FIG. 5 illustrates signalling for registering further authentication information with the relying party;

FIG. 6 depicts signalling for retrieving authentication data from a network accessible storage;

FIG. 7 shows signalling for a further authenticator authenticating to the relying party;

FIG. 8 illustrates signalling for authenticating the initial authenticator to the relying party;

FIGS. 9 and 10 depict flowcharts for introducing authenticators;

FIGS. 11 and 12 show flowcharts for registering the initial authenticator with the relying party;

FIGS. 13 to 15 illustrate flowcharts for registering authentication information with the relying party;

FIGS. 16 and 17 depict flowcharts for retrieving authentication data from the network accessible storage;

FIGS. 18 and 19 show flowcharts for authenticating the further authenticator to the relying party;

FIGS. 20 and 21 illustrate flowcharts for authenticating the initial authenticator to the relying party; and

FIG. 22 shows machine readable storage storing machine instructions for authenticating an authenticator to the relying party.

### DETAILED DESCRIPTION

Authentication of a user via an authentication device using single factor ‘what you have’ is becoming more frequent. This type of authentication is authentication based on ‘what you have’ as opposed to authentication using ‘what you know’; the latter relying on, for example, passwords. However, it is vulnerable to the user losing their device and, therefore, becoming locked out of an account or being denied access or control over an associated resource. To avoid this, some users may independently register multiple authentication devices when an account is created. Nevertheless, given the unpredictability of when a user may create an account or otherwise register with an account or control a resource, the user may not have multiple authentication devices available to them during such a registration process. Furthermore, if a user does possess all such authentication devices, there is a risk of losing all of the devices simultaneously.

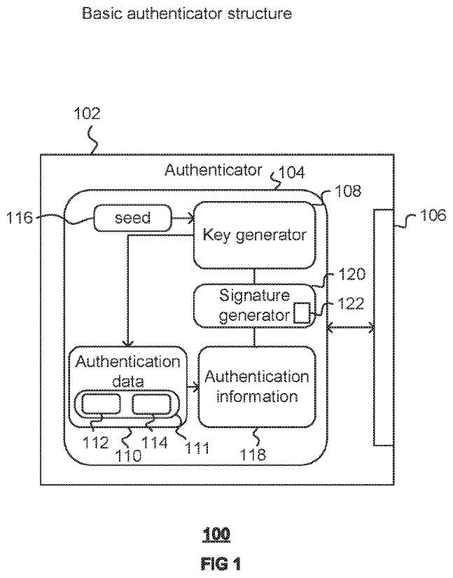

Referring to FIG. 1, there is shown a view 100 of an authenticator 102, the authenticator 102 comprises a processor 104 and a communication interface 106. The processor can be configured to implement an authentication data generator such as, for example, a key generator 108. The key generator is arranged to generate authentication data 110. Examples can be realised in which the authentication data generator generates authentication data 110 comprising a public credential 112 and private authentication data 114. Examples can be realised in which the authentication data 110 comprises public-private authentication data such as, for example, a public-private key pair. The public-private key pair can be a public-private key pair for use in a digital signature scheme. Therefore, examples can be realised in which the public authentication data 112 comprises the public key of the public-private key pair. Examples can be realised in which the private authentication data 114 comprises the private key of the public-private key pair.

The key generator can be responsive to seed data 116. In the example depicted in FIG. 1, the seed data can comprise any type of data.

Throughout the application, the term ‘authenticator’ should be interpreted as an authentication device or system such as, for example, authentication hardware, authentication software or a combination of authentication hardware and software. Such authentication software can comprise an authentication application or authentication app. For example, an authenticator could comprise a Yubico authenticator USB or a Yubico authenticator app.

The authentication data can be used to derive authentication information 118. The authentication information 118 comprises information sent to a relying party to authenticate the authenticator 102 to the relying party.

Throughout the application, references to communications and communicating with another entity such as, for example, an authenticator, a relying party or any other device, comprise both direct and indirect communications. Such indirect communications can be via an intermediary device or system or via a number of intermediary devices or systems. For example, any authenticator described herein could be a USB or other device that plugs into an intermediary device or system to communicate with another entity such as another authenticator, relying party or any other device. Such an intermediary device or system, or intermediary devices or systems, can comprise a laptop, a tablet, desktop, a smartphone, an electronic wearable device or any other computing device or system.

The authenticator 102 also comprises a signature generator 120. The signature generator 120 is arranged to generate a signature 122 to be used in authenticating the authenticator 102 to a relying party. Therefore, examples can be realised in which the authentication information comprises the signature 122.

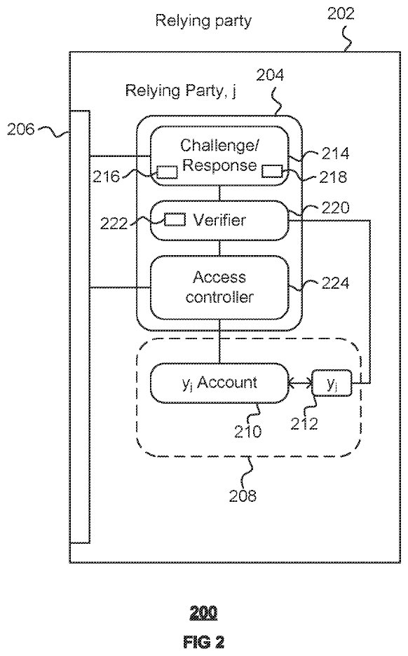

Referring to FIG. 2, there is shown a view 200 of a relying party 202. The relying party is an example of the above-mentioned relying party. The relying party comprises a processor 204. The relying party comprises a communications interface 206. The relying party also comprises a resource or set of resources 208. The resource or set of resources 208 can comprise, for example, a user account, multiple user accounts or some other resource such as, for example, processor capacity or memory or the like. In the example depicted, the resource or set of resources 208 comprises a user account 210 that is associated with at least one respective identifier or public credential 212. The identifier or public credential 212 is associated with a set of authenticators. The set of authenticators can comprise the authenticator 102. The public credential 212 is an example of the above-described public credential 112. The at least one respective identifier can comprise an identifier that is common to both an initial authenticator and a further authenticator, which are described below. Alternatively, the at least one respective identifier can comprise a set of identifiers. The set of identifiers can comprise at least an identifier associated with the initial authenticator and at least an identifier associated with the further authenticator.

The processor 204 is configured to implement a challenge/response protocol 214. The challenge/response protocol 214 is arranged to issue challenges 216 and associated relying party data 218 to authenticators such as any of the authenticators described herein. The challenge/response protocol 214 is also arranged to process any challenge responses received, via the communications interface 206, from, or associated with, an authenticator. The processor 204 also comprises, or is arranged to implement, a verifier 220. The verifier is arranged to verify the authenticity or veracity of authentication information 222 provided to the relying party 202 by an authenticator in response to a challenge issued under the challenge/response protocol 214. The verifier 220 determines whether or not the provided authentication information 222 is valid or invalid. The processor also comprises an access controller, or resource manager, 224, that is responsive to the output of the verifier 220 to grant or prevent access to the resource or set of resources 208. The authentication information 222 is an example of the above-described authentication information 118.

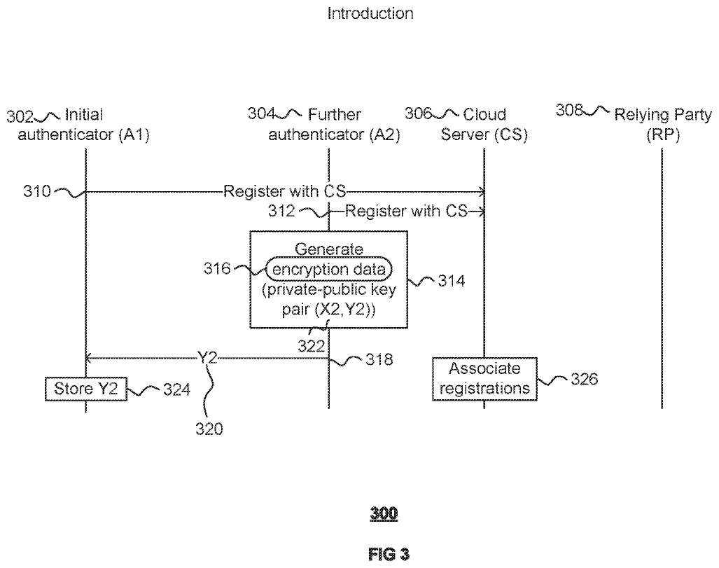

Referring to FIG. 3, there is shown a view 300 of signalling according to an example. The signalling is associated with an introductory or provisioning phase of authentication. An example of authentication will be described with reference to an initial authenticator 302, a further authenticator 304, a cloud server 306, and a relying party 308.

The initial authenticator 302 and the further authenticator 304 are examples of the above-described authenticator 102. The cloud server 306 is an example of the above-described network accessible storage.

The initial authenticator 302, at 310, sends data or a message, or other type of signal, to a cloud server 306 indicating that the initial authenticator 302 wishes to register with the cloud server 306. Similarly, the further authenticator 304, at 312, sends a respective message to the cloud server 306 indicating that the further authenticator wishes to register with the cloud server. The further authenticator 304, at 314, generates encryption data 316. Examples can be realised in which the encryption data comprises a public-private encryption key pair such as (X2,Y2) illustrated in FIG. 3. At 318, the further authenticator 304 sends a public portion 320 of the encryption data 316 to the initial authenticator and retains a private portion 322 of the encryption data 316 to recover authentication data associated with the further authenticator 304. The initial authenticator 302, at 324, stores the public portion 320 for later use. The public portion 320 can comprise the public key of such a public-private encryption key pair. The messages sent at 310 and 312 can be sent contemporaneously in time or spaced apart in time. Furthermore, the order of the operations shown in FIG. 3 is not limited to the order shown, other than the encryption data 316 being generated before the public key 320 is sent to the initial authenticator 302 at 318. At 326, the cloud server 306 creates an association between the registrations at 310 and 312 to note that the registrations are associated with a set of authenticators. In the example shown, the set of authenticators comprises at least the initial authenticator 302 and the further authenticator 304. The association can be responsive to data common to the initial authenticator 302 and the further authenticator 304 such as, for example, a public credential of the further authenticator 304, as described above with reference to FIG. 2, a hash of such a public credential or other data derived from such a public credential, or some other reference or index common to the initial authenticator 302 and the further authenticator 304.

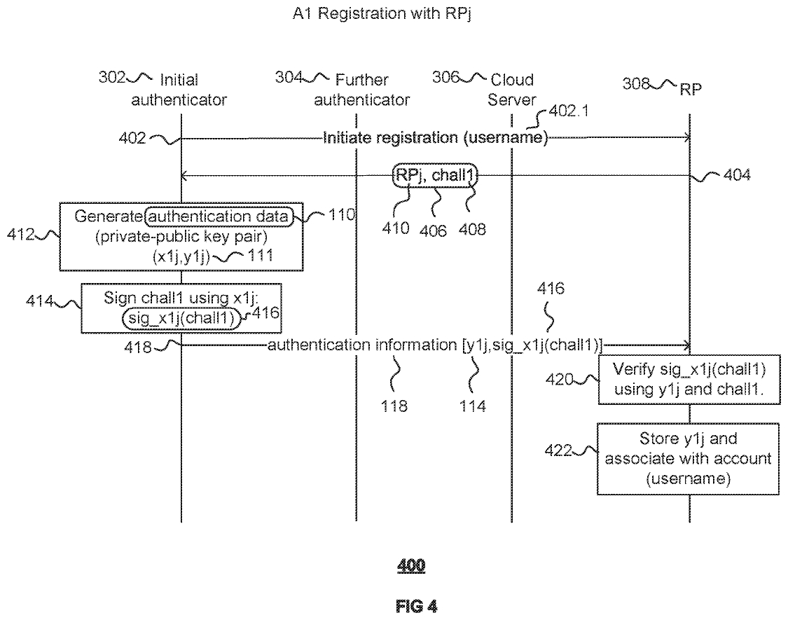

Referring to FIG. 4, there is shown a view 400 of registration signalling between the initial authenticator 302, the further authenticator 304, the cloud server 306, and the relying party 308. The registration signalling is arranged to register authentication information with the relying party 308. The authentication information registered with the relying party 308 will be used during a subsequent authentication to authenticate an associated authenticator. The initial authenticator 302, at 402, initiates registration with the relying party 308. Initiating registration with the relying party 308 can comprise the initial authenticator 302 sending a registration message to the relying party 308 requesting registration with the relying party 306 with a view to being allocated a resource or set of resources 208. The registration message can comprise an identifier 402.1 associated with at least one, or both, of the initial authenticator 302 and the further authenticator, that is, associated with the set of authenticators. Additionally, or alternatively, the identifier can comprise an identifier associated with the user or owner of the set of authenticators. The identifier can comprise, for example, a username or other identifier. The relying party 308, at 404, as part of the challenge/response 214 protocol, sends a message 406 comprising at least a challenge 408 to be used by the initial authenticator 302 in registering authentication information with the relying party 308. Examples can be realised in which the message 406 also comprises a string or other identifier 410 associated with the relying party 308. The examples described herein can realise the challenge/response protocol in the form of the, or a, FIDO protocol such as, for example, the FIDO2 protocol. In response to receiving the message 406 comprising the challenge 408, the initial authenticator 302, at 412, generates the authentication data 110. The authentication data can comprise the public-private key pair 111. The initial authenticator 302, at 414, signs the challenge 408. Signing the challenge 408 produces a signature 416. The signature is produced using the generated authentication data 110. Examples can be realised in which the signature is produced by signing the challenge 408 using the private authentication data, x1j. At 418, the initial authenticator 302 sends the authentication information 118 to the relying party 308. The authentication information 118 is used to register the initial authenticator with the relying party 308 and to authenticate the initial authenticator 302 to the relying party 308. The authentication information 118 can comprise the signature 416. The authentication information 118 can additionally comprise the public credential 114. Examples can be realised in which the public credential 114 is sent to the relying party other than with the authentication information comprising the signature 416. The relying party 308, at 420, verifies the authentication information 118 and, if the verification is valid, associates, at 422, the resource or set of resources 208 with the public credential 114 of the authentication information 118.

Examples can be realised in which verifying, at 420, comprises verifying the signature 416 using the public credential 114 and the challenge 408.

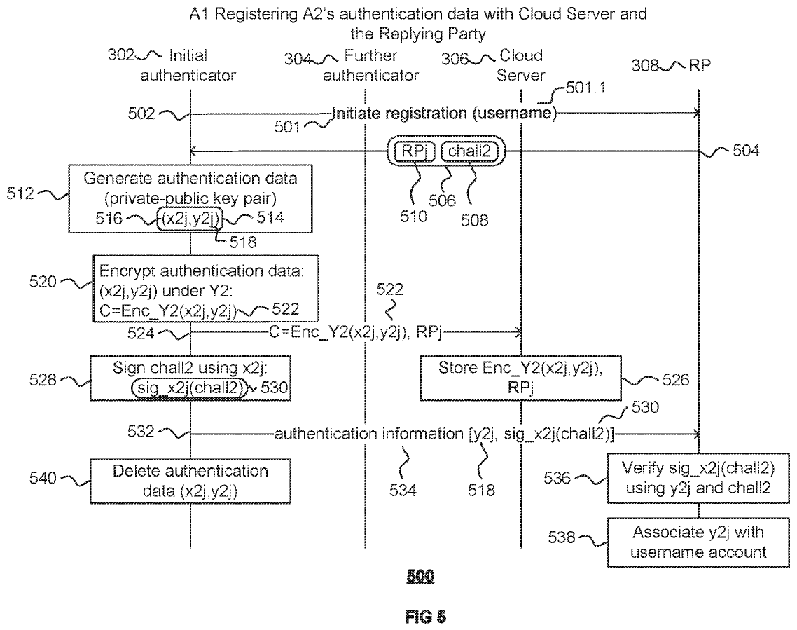

Referring to FIG. 5, there is shown a view 500 of the initial authenticator 302, on behalf of the further authenticator 304, registering authentication information and authentication information associated with the further authenticator 304 with the relying party 308 and the cloud server 306 respectively. The initial authenticator 302, at 502, initiates registration with the relying party 308. Initiating registration comprises sending a registration message 501 to the relying party 308 requesting registration with the relying party 308. The message 501 can comprise an identifier 501.1 associated with the set of authenticators, which, in the example shown, comprises the initial authenticator 302 and the further authenticator 304. Examples can be realised in which the identifier is a username or other identifier. The identifier or username is used to associate the set of authenticators with the same resource or set of resources 208, as indicated below.

In response to receiving the registration request 501, the relying party, at 504, sends a message 506 comprising a challenge 508. The message 506 can also comprise a string or other identifier 510 associated with the relying party 308. The string or other identifier 510 associated with the relying party 308 is used to distinguish the relying party 308 from other relying parties. In response to receiving the message 506 comprising the challenge 508, the initial authenticator 302, generates, at 512, authentication data 514 associated with the further authenticator 304. The authentication data 514 comprises private authentication data 516 and a public credential 518. Examples can be realised in which the authentication data 514 comprises a public-private key pair such that the private authentication data 516 comprises the private key of the public-private key pair and the public credential 518 comprises the public key of the public-private key pair. The authentication data 514 is an example of the above described authentication data 110.

The initial authenticator 302, at 520, encrypts the authentication data 514 using the public encryption data 320 previously stored by the initial authenticator 302. Encrypting the authentication data 514 produces encrypted authentication data 522.

The encrypted authentication data 522 is sent, at 524, by the initial authenticator 302, to the cloud server 306. It will be appreciated, therefore, that the encrypted authentication data is an example of data derived from the authentication data to be sent to the network storage commonly accessible by the initial authenticator and the further authenticator.

At 526, the cloud server 306 stores the encrypted authentication data 522 together with the string or other identifier 510 associated with the relying party.

At 528, the initial authenticator 302, produces a signature 530 associated with the challenge 508 and the private authentication data 516 of the further authenticator 304, that is, the challenge 508 is signed using the private authentication data 516.

At 532, authentication information 534, comprising the public credential 518 and the signature 530 is sent by the initial authenticator 302 to the relying party 308.

At 536, the relying party 308 verifies the signature 530 using the public credential 518 and the challenge 508. If the verification indicates that the signature is valid, the relying party 308, at 538, associates the public credential with the resource or set of resources 208. In the example depicted, it can be seen that the relying party 308 associates the public credential 518 with an account associated with the username 501.1. The initial authenticator 302, at 540, can delete the authentication data 514.

Although the signalling shown in FIG. 5 generates the authentication data 514 in response to receiving the message 506 containing the challenge, examples can be realised in which the authentication data 514 is generated at some other point in time, which can be before receiving the message 506 containing the challenge 508. Furthermore, although the signalling depicted in FIG. 5 indicates that the cloud server 306 is provisioned before the relying party 308 to support authenticating the further authenticator 304, examples can be realised in which the relying party 308 is provisioned before the cloud server 306 to support authenticating the further authenticator 304. The order of registering with the cloud server 306 and registering with the relying party 308 is interchangeable or reversible.

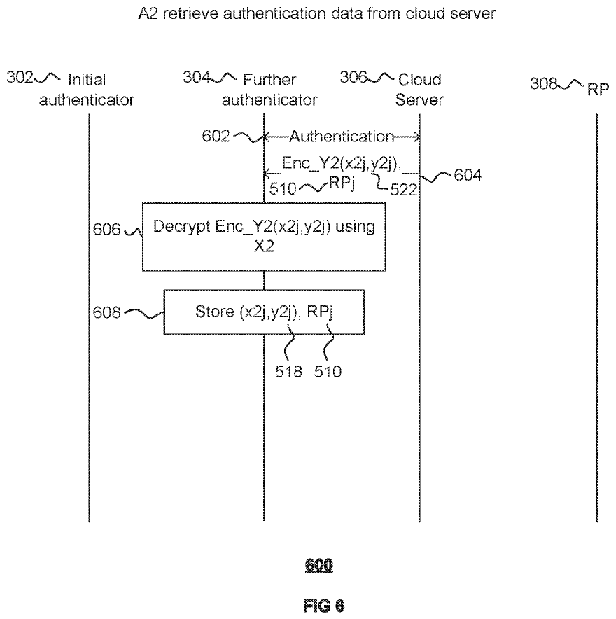

Referring to FIG. 6, there is shown a view 600 of authentication signalling associated with the further authenticator 304 retrieving the encrypted authentication data 522 from the cloud server 306.

At 602, the further authenticator 304 is authenticated by the cloud server 306.

Following successfully authenticating the further authenticator 304 by the cloud server 306, the cloud server, at 604, sends the encrypted authentication data 522 to the further authenticator 304. At 606, the further authenticator 304 decrypts the received encrypted authentication data 522 using a corresponding decryption key. The corresponding decryption key is an example of the above-described private portion 322 of the encryption data 316. At 608, the further authenticator 304 stores the recovered or decrypted authentication data 518 together with the string or other identifier 510 associated with the relying party 308. The recovered or decrypted authentication data 518 is an example of the above-described authentication data 110.

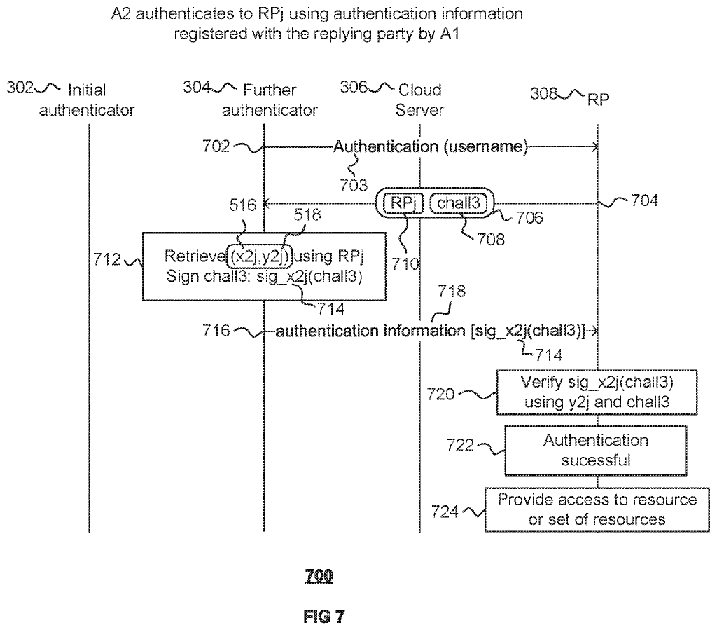

Referring to FIG. 7, there is shown a view 700 of signalling associated with the further authenticator 304 being authenticated by, or authenticating itself to, the relying party 308 using authentication information previously registered with the relying party 308 by the initial authenticator 302 as described above with reference to FIG. 5.

At 702, the further authenticator 304 sends an authentication request 703 to the relying party 308. The authentication request can comprise the identifier such as, for example, the username, associated with the initial authenticator 302 and the further authenticator 304 that was used to register the public credential 518 with the relying party 308 as described above with reference to FIG. 5. In response to the authentication request, the relying party 308, at 704, sends a message 706 comprising a challenge 708. The message 706 can also comprise a string or other identifier 710 associated with the relying party 308. At 712, the further authenticator 304 retrieves the authentication data 514 associated with the relying party 308 using the relying party string or identifier 710 and generates a signature 714. The signature 714 can be generated by the further authenticator signing the challenge 708 using the private authentication data 516.

At 716, the further authenticator 304 sends authentication information 718 to the relying party 308. The authentication information 718 comprises the signature 714. At 720, the relying party 308 verifies the authentication information 718. Examples can be realised in which the signature 714 is verified using the previously registered public credential 518 and the challenge 708. A determination is made, at 722, whether or not the verification was successful.

If the verification is successful, the relying party 308 provides access, at 724, to the resource or set of resources 208 associated with the username or other identifier associated with the initial authenticator 302 and the further authenticator 304.

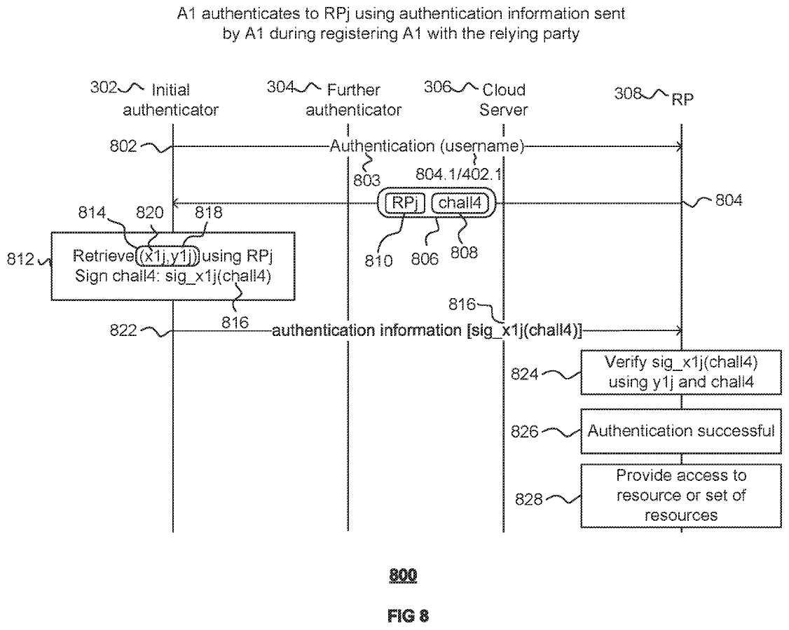

Referring to FIG. 8, there is shown a view 800 of signalling associated with the initial authenticator 304 being authenticated by, or authenticating itself to, the relying party 308.

At 802, the initial authenticator 304 sends an authentication request 803 to the relying party 308. The authentication request 803 can comprise the identifier 804.1/402.1 such as, for example, the username associated with the initial authenticator 302 and the further authenticator 304. The identifier is the same identifier 402.1 as that used when registering the initial authenticator 302 with the relying party 308 as described with reference to FIG. 4. In response to the authentication request, the relying party 308, at 804, sends a message 806 comprising a challenge 808. The message can also comprise a string or other identifier 810 associated with the relying party 308. At 812, the further authenticator 304 retrieves the authentication data 814 associated with the relying party 308 using the relying party string or identifier 810 and generates authentication information 816. The authentication data 814 is an example of the authentication data 111 described above with reference to FIG. 4. The authentication information 816 can comprise a signature. The authentication data 814 can comprise a public credential 818 and private authentication data 820, which can be realised, for example, as a public-private key pair. The signature 816 can be generated by the initial authenticator 302 signing the challenge 808 using the private authentication data 820.

At 822, the initial authenticator 302 sends the authentication information 816 to the relying party 308. As indicated, the authentication information 816 comprises the signature. Examples can be realised in which the authentication information 816 can additionally comprise either the public credential 818 or a hash of the public credential 818. The public credential 818 is an example of the public credential 114 described above with reference to FIG. 4. At 824, the relying party 308 verifies the authentication information 816. Examples can be realised in which the signature is verified using the public credential 114/818, previously registered during the registration phase as described above with reference to FIG. 4, and the challenge 808. A determination is made, at 826, whether or not the verification was successful.

If the verification is successful, the relying party 308 provides access, at 828, to the resource or set of resources 208 associated with the username or other identifier associated with the initial authenticator 302 and the further authenticator 304.

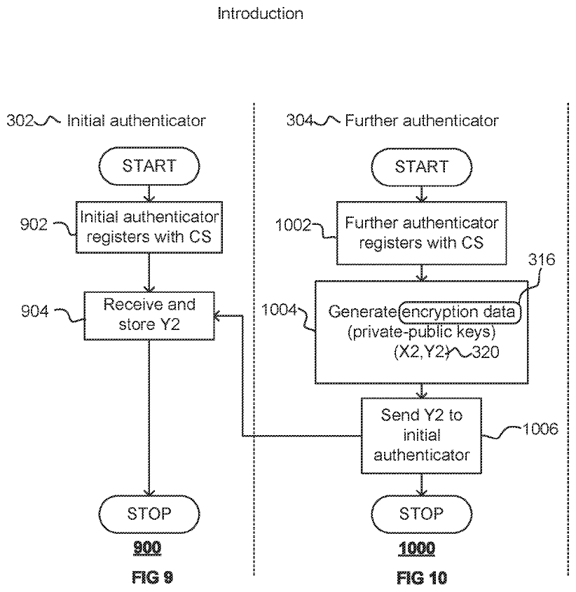

Referring to FIG. 9, there is shown a view of a flowchart 900 of operations performed by the initial authenticator 302 during the introductory phase.

At 902, the initial authenticator 302 registers with the cloud server 306 as described above with reference to FIG. 3. At 904, the initial authenticator 302 receives and stores the public encryption data 320 sent by the further authenticator 304.

Referring to FIG. 10, there is shown a view of a flowchart 1000 of operations performed by the further authenticator 304 as described above with reference to FIG. 3. At 1002, the further authenticator 304 registers with the cloud server 306. The further authenticator 304 generates the encryption data 316 and sends, at 1006, the public portion 320 of the encryption data 316 to the initial authenticator 302.

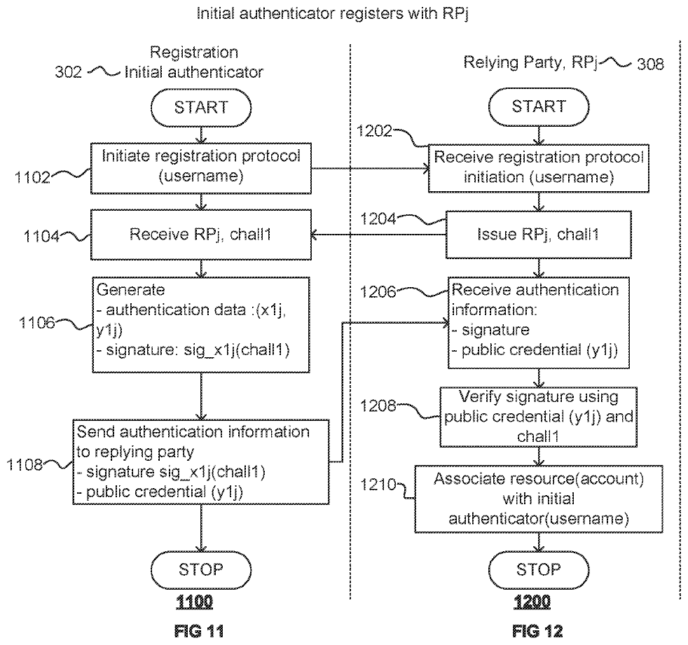

Referring to FIG. 11, there is shown a view of a flowchart 1100 depicting operations performed by the initial authenticator 302 when registering with the relying party 308 as described above with reference to FIG. 4. At 1102, the initial authenticator 302, initiates registration, or initiates a registration protocol, to register with the relying party 308.

At 1104, the initial authenticator 302 receives the message 406 comprising the challenge 408. The message 406 can additionally comprise the string or identifier 410 associated with the relying party. At 1106, the initial authenticator 302, generates the authentication data 111 associated with the initial authenticator 302 together with the corresponding signature 416. As indicated above, the corresponding signature can be generated by signing the challenge 408 using the private authentication data, x1j, of the generated authentication data.

At 1108, the initial authenticator 302 sends the authentication information 112 to the relying party 308. The authentication information sent to the relying party 308 comprises the signature 416 together with the public credential 114.

Referring to FIG. 12, there is shown a view of a flowchart 1200 describing operations performed by the relying party 308 as described above with reference to FIG. 4. At 1202, the relying party 308 receives the initiating registration request issued by the initial authenticator 302. The request comprises the username or other identifier 402.1 associated with at least one, or both, of the initial authenticator and the further authenticator 302 and 304 respectively.

At 1204, the relying party issues the challenge message 406 to the initial authenticator. The challenge message 406 comprises the challenge 408 and can additionally comprise the string or other identifier 410 associated with the relying party.

At 1206, the relying party 308 receives the authentication information output by the initial authenticator 302.

At 1208, the relying party 308 verifies the signature. The verification uses the public credential 114 and the challenge 408 to determine the validity of the signature.

At 1210, the relying party 308 associates the resource or set of resources 208 with the public credential 114 associated with the initial authenticator 302.

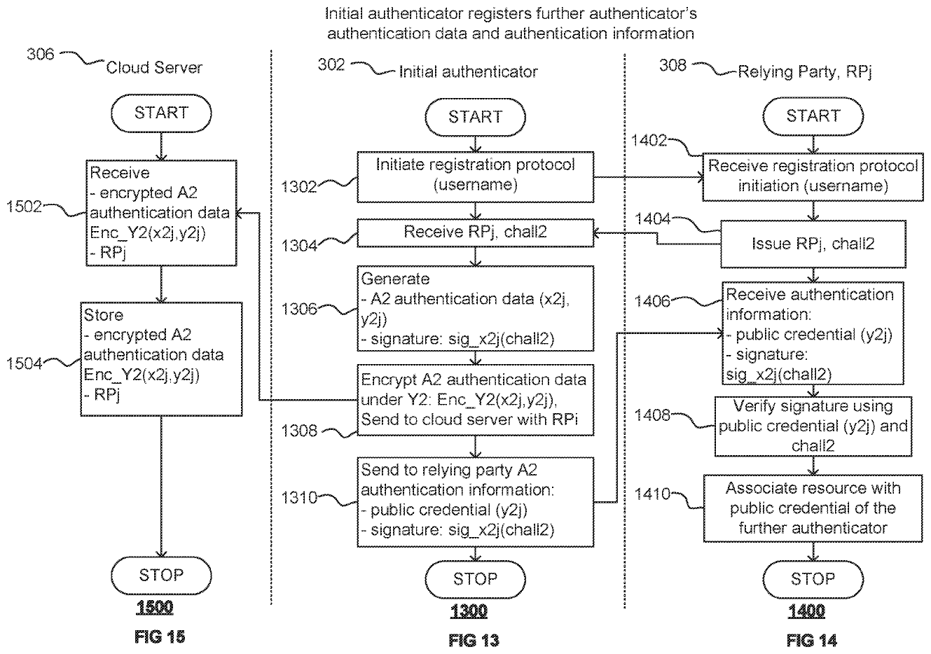

FIGS. 13 to 15 show views of flowcharts 1300, 1400 and 1500 for registering, by the initial authenticator 302, the authentication data 514/522 associated with the further authenticator 304 with the cloud server 306 and for registering the authentication information 534 associated with the further authenticator 304 with the relying party 308.

Referring to FIG. 13, the flowchart 1300 depicts operations performed by the initial authenticator to register the authentication data associated with the further authenticator 304 with the relying party 308 via the cloud server 306 and to register authentication information with the relying party 308.

At 1302, the initial authenticator 302 initiates the registration protocol to register with the relying party 308.

At 1304, the initial authenticator receives the message 506 comprising the challenge 508 and the string or other identifier 510 issued by the relying party 308. The initial authenticator 302, at 1306, generates the authentication data associated with the further authenticator 304 together with the signature 530. The initial authenticator 302, at 1308, encrypts the authentication data using the encryption key 320 associated with the further authenticator 304, and sends the encrypted authentication data 522 to the cloud server 306.

At 1310, the initial authenticator 302, sends the authentication information 534 associated with the further authenticator 304 to the relying party 308. As indicated above, the further authentication information 534 comprises the public credential 518 and the signature 530 generated using the private authentication data 516.

Referring to FIG. 14, the flowchart 1400 shows the operations performed by the relying party 308.

At 1402, the relying party 308 receives the initial registration request 501 of the registration protocol.

At 1404, the relying party 308 issues the challenge message 506 comprising the challenge 508 and the string or identifier 510 associated with the relying party 308.

At 1406, the relying party 308 receives the authentication information 534.

At 1408, the relying party verifies the authentication information. Verifying the authentication information comprises verifying the signature using the public credential 518 and the challenge 508.

At 1410, if the verification is successful, that is, if the signature is valid, the relying party 308 associates the resource or set of resources 208 with the public credential 518 received during the registration protocol, which is associated with the further authenticator 304.

Referring to FIG. 15, the flowchart 1500 illustrates operations performed by the cloud server 306. At 1502, the cloud server 306 receives the encrypted authentication data 522 associated with the further authenticator 304. The cloud server 306 stores the encrypted authentication data 522, at 1504, for sending to the further authenticator 304.

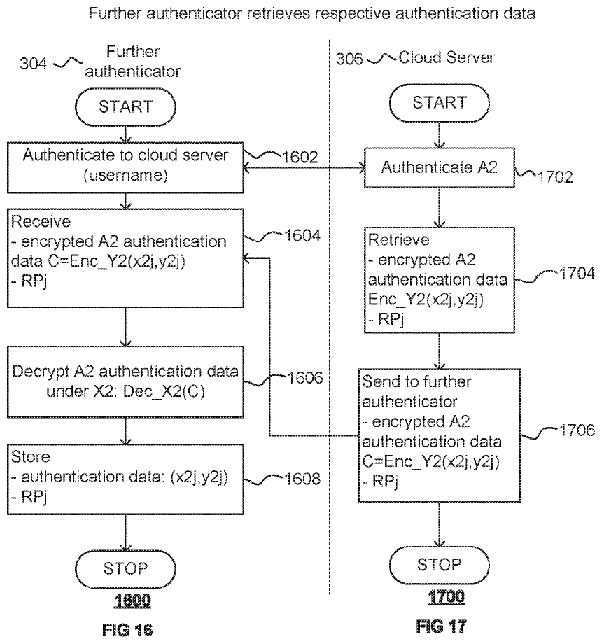

FIGS. 16 and 17 show a pair of flowcharts 1600 and 1700 respectively for the further authenticator 304 retrieving the encrypted authentication data 522 from the cloud server 306.

Referring to FIG. 16, it can be seen that the flowchart 1600 depicts operations performed by the further authenticator 304. At 1602, the further authenticator 304, initiates authentication with the cloud server 306. At 1604, assuming the authentication initiated at 1602 was successful, the further authenticator receives the encrypted authentication data 522 associated with the further authenticator together with the relying party identifier. It will be appreciated that examples can be realised in which the further authenticator 304 is not authenticated before being sent the encrypted authentication data 522. In such circumstances, the supplied encrypted authentication data 522 can be decrypted by the further authenticator 304 since it holds the corresponding decryption key whereas a malicious authenticator (not shown) would merely receive encrypted authentication data that it could not decrypt.

At 1606, the further authenticator 304 decrypts the encrypted authentication data 522 to recover the authentication data 514 associated with the further authenticator 304.

At 1608, the further authenticator stores the authentication data 514 in a manner associated with the relying party using, for example, the relying string or identifier 510.

Referring to FIG. 17, there is shown a view of the flowchart 1700 describing the operations performed by the cloud server 306 to provide the encrypted authentication data 522 to the further authenticator 304.

At 1702, the cloud server 306 authenticates the further authenticator 304.

At 1704, assuming the authentication of the further authenticator 302 was successful, the cloud server 306 retrieves the encrypted authentication data 522 and the associated relying party string or identifier 510 and sends, at 1706, the encrypted authentication data 522 associated with the further authenticator 304 and the relying party string or identifier to the further authenticator 304.

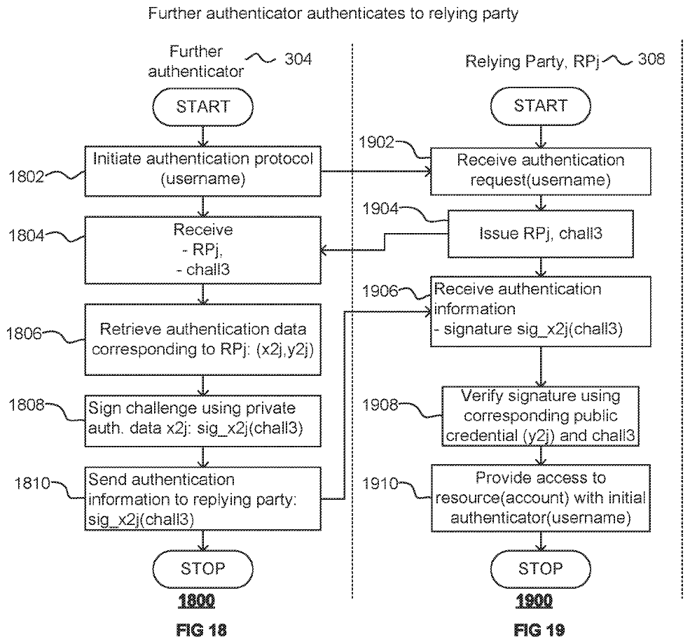

Referring to FIGS. 18 and 19, there is shown a pair of flowcharts 1800 and 1900 respectively for authenticating the further authenticator 304 to the relying party 308.

Referring to FIG. 18, there is shown the flowchart 1800 of the operations performed by the further authenticator 304 in authenticating to the relying party 308.

At 1802, the further authenticator 304 initiates an authentication protocol to authenticate itself to the relying party 308.

At 1804, the further authenticator receives the challenge message 706 comprising the challenge 708 and the relying party string or identifier 710.

The further authenticator 304 retrieves, at 1806, the authentication data associated with the further authenticator that corresponds to the relying party 308. At 1808, the further authenticator 304, signs the challenge 708 using the private authentication data, x2j. At 1810, the further authenticator 304 sends the authentication information 718 to the relying party 308. As indicated above the authentication information comprises the signature 714. The authentication information can additionally comprise data associated with or derived from the associated public credential of the authentication data 518 of the further authenticator 304. The data associated with the public credential can comprise a copy of the public credential per se or a hash of the public credential to allow the relying party 308 to access or otherwise identify the corresponding previously registered public credential 518.

Referring to FIG. 19, there is shown a view of the flowchart 1900 describing the operations performed by the relying party 308 in authenticating the further authenticator 304.

At 1902, the relying party 308 receives the authentication request 804 comprising the username. At 1904, the relying party 308 issues the challenge message 806 comprising the challenge 708 and the string or identifier 710 associated with the relying party. At 1906, the relying party receives the authentication information 718. The authentication information comprises the signature 714. The authentication information can additionally comprise at least one of the public credential of the authentication data associated with the further authenticator or a hash of such a public credential or other data representing a processed form of, or derived from, the public credential associated with the further authenticator.

At 1908, the relying party 308 verifies the authentication information. Verifying the authentication information comprises verifying the received signature 714 using the previously registered public credential 114 and the challenge 708.

At 1910, the relying party 308, assuming the verification is successful, provides access to the resource or set of resources 208 associated with the further authenticator 304.

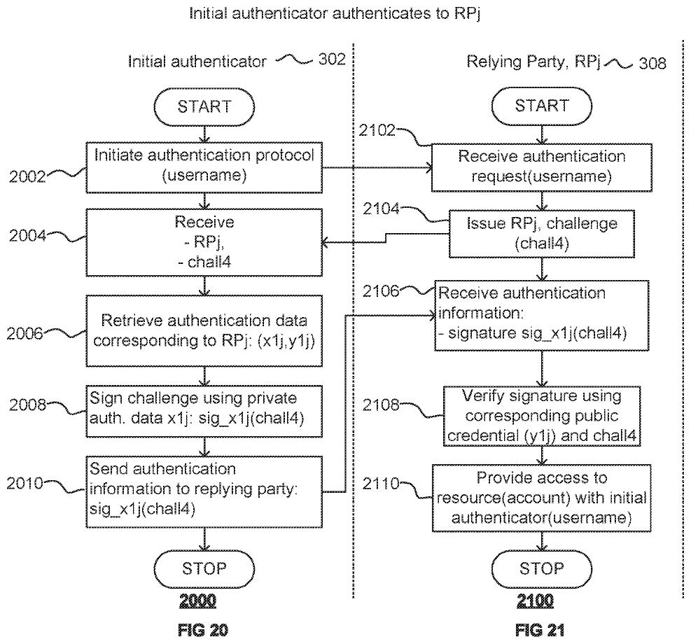

Referring to FIGS. 20 and 21, a pair of flowcharts 2000 and 2100 is depicted for authenticating the initial authenticator 302 to the relying party 308.

FIG. 20 depicts the flowchart 2000 showing the operations performed by the initial authenticator 302 in authenticating to the relying party 308.

At 2002, the initial authenticator initiates the authentication protocol.

At 2004, the initial authenticator receives the challenge 808 and the string or identifier 810 associated with the relying party 308.

At 2006, the initial authenticator 302 retrieves or generates authentication data 814. The authentication data 814 comprises the private authentication data 820 and the public credential 818.

At 2008, the initial authenticator generates a signature. Examples can be realised in which the signature is generated by signing the received challenge 808 with the private authentication data 820.

At 2010, the authentication information comprising the signature is sent, by the initial authenticator 302, to the relying party 308.

Referring to FIG. 21, there is shown a view of the flowchart 2100 depicting the operations performed by the relying party 308 when authenticating the initial authenticator 302.

At 2102, the relying party 308 receives the authentication request. The authentication request can comprise an identifier, such as the username, associated with the resource or set of resources 208 associated, in turn, with initial authenticator 302.

The relying party 308, at 2104, issues the message 806 comprising the challenge 808 and the string or other identifier 810 to the initial authenticator 302.

The relying party 308 receives, at 2106, the authentication information output by the initial authenticator 302.

At 2108, the relying party 308, verifies the authentication information. Verifying the authentication information can comprise verifying the signature. The signature is verified using the previously registered public credential 818 and the challenge 808. Assuming the signature to be valid, the relying party 308, at 2110, provides access to the resource or set of resources 208 associated with the identifier 804.1/402.1 associated with the initial authenticator.

Examples can be realised in the form of machine instructions that can be processed by a machine. The machine can comprise a computer, processor, DSP, FPGA, circuitry or other logic, processor core, compiler, translator, interpreter or any other instruction processor. Processing the instructions can comprise interpreting, executing, converting, translating or otherwise giving effect to the instructions. The instructions can be stored on a machine readable medium, that is, machine readable storage. The machine readable storage can store the instructions in a non-volatile, non-transient, manner or in a volatile, transient, manner. The instructions can be arranged to give effect to any and all operations described herein taken jointly and severally in any and all permutations. The instructions can be arranged to give effect to any and all of the operations, devices, authenticators, flowcharts, protocols or methods described herein taken jointly and severally in any and all permutations. In particular, the machine instructions can give effect to, or otherwise implement, the operations of the flowchart taken jointly and severally in any and all permutations.

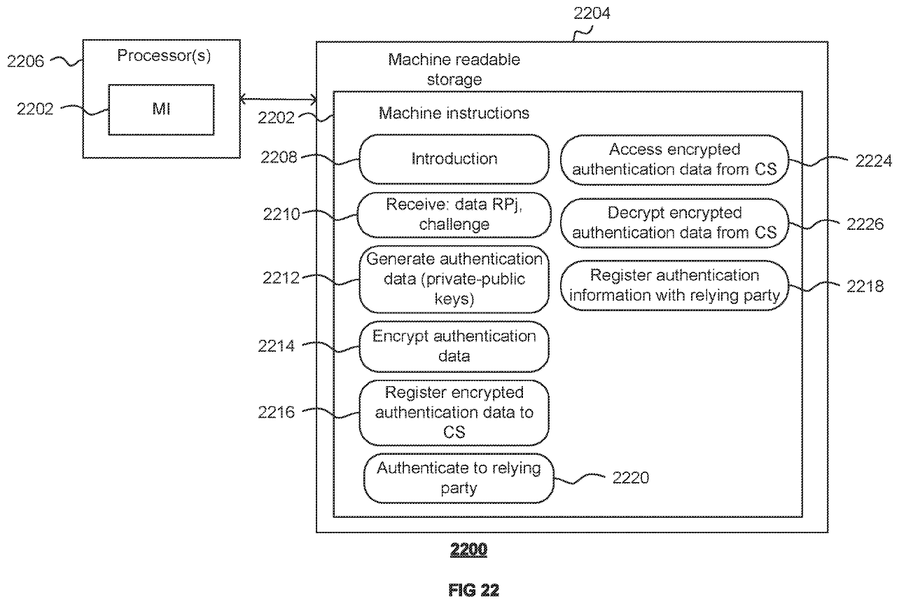

Therefore, FIG. 22 shows a view 2200 of machine readable instructions 2202 stored using machine readable storage 2204 for implementing the examples described herein. The machine instructions 2202 can be processed by, for example, a processor 2206 or other processing entity, such as, for example, an interpreter, as indicated above.

The machine readable instructions comprise:
instructions 2208 to give effect to the introduction or introductory phase as described above with reference to, in particular, FIG. 3, FIG. 9 and FIG. 10;
instructions 2210 to receive a challenge together with or without the corresponding relying party string or identifier; as described above with respect to the signalling diagrams shown in FIGS. 4, 5, 7 and 8 and FIGS. 11, 13, 18 and 20;
instructions 2212 to generate the above described authentication data 514;
instructions 2214 to encrypt the authentication data to produce the above described encrypted authentication data 522;
instructions 2216 to register the encrypted authentication data 522 with the cloud server 306;
instructions 2218 to register authentication information with the relying party 308;
instructions 2220 to authenticate an authenticator 302/304 to the relying party 308;
instructions 2224 to access the encrypted authentication data 522 stored by the cloud server 306; and
instructions 2226 to decrypt the encrypted authentication data accessed or stored at the cloud server.

The challenges described above and depicted in the figures as chall1, chall2, chall3, and chall4 are all different. Also, the signatures described herein are examples of proof of possession of corresponding or respective private authentication data.

Examples can be realised according to the following clauses;
Clause 1—machine readable storage storing instructions arranged, when processed, to facilitate authentication using an authenticator, the instructions comprising instructions to:
generate, by an initial authenticator (A1), authentication data (a public-private key pair: (x2j,y2j)) associated with a further authenticator, (A2); the authentication data comprising private data (x2j) and a public credential (y2j); the public credential and private data (x2j,y2j) being for use in producing authentication information to authenticate the further authenticator to a relying party (RP); and
send data derived from the authentication data (Enc_Y2(x2j,y2j)) to network storage (cloud server) commonly accessible by the initial authenticator and the further authenticator.
Clause 2—the machine readable storage of clause 1, comprising instructions to: register the public credential (y2j) with the relying party (RPj).
Clause 3—the machine readable storage of any preceding clause, in which the instructions to send data associated with the authentication data (Enc_Y2(x2j,y2j)) to network storage (cloud server) commonly accessible by the initial authenticator and the further authenticator comprises instructions to derive the data associated with the authentication data by processing (encrypting) the authentication data (Enc_Y2(x2j,y2j).
Clause 4—the machine readable storage of clause 3, comprising instructions to: receive, from the further authenticator (A2), a public key (Y2) of encryption data (X2, Y2) associated with the further authenticator (A2).
Clause 5—the machine readable storage of clause 4, in which the instructions to encrypt the authentication data (x2j,y2j) comprise instructions to: encrypt the authentication data (x2j,y2j) using the public key (Y2).
Clause 6—the machine readable storage of any preceding clause, comprising instructions to: generate, by the initial authenticator (A1), authentication data (a public-private key pair: (x1j,y1j)) associated with the initial authenticator, (A1); the authentication data comprising private data (x1j) and a public credential (y1j) for use in authenticating the initial authenticator (A1) to the relying party (RP); and send authentication information (y1j,sigx1j(chall)), comprising the public credential (y1j) associated with the initial authenticator (A1) and proof of possession of the private data (x1j), to the relying party (RPj).
Clause 7—machine readable storage storing instructions arranged, when processed, to: access, by a further authenticator (A2), via network storage commonly accessible to an initial authenticator (A1) and the further authenticator (A2), data associated with authentication data (Enc_Y2(x2j,y2j)) with the further authenticator for authenticating the further authenticator to a replying party; the authentication data having been generated by the initial authenticator (A1).
Clause 8—the machine readable storage of clause 7, comprising instructions to: authenticate the further authenticator (A2) to the relying partying using authentication information derived from the accessed authentication data associated with the further authenticator (A2).
Clause 9—the machine readable storage of either of clauses 7 and 8, comprising instructions to: decrypt the accessed authentication data (Enc_Y2(x2j,y2j)) to use the decrypted authentication data (x2j,y2j) to authenticate the further authenticator (A2) to the relying party (RP).
Clause 10—the machine readable storage of any of clauses 7 to 9, comprising instructions to: send a public key (Y2) of encryption data (X2, Y2) associated with the further authenticator (A2) to the initial authenticator (A1) for use by the initial authenticator (A1) in encrypting the authentication data associated with the further authenticator (A2).
Clause 11—An authenticator device for authenticating to a relying party; the authenticator device comprising logic or circuitry to:
a. access authentication data retrieved from network accessible storage; the authentication data having been generated by a different authentication device;
b. generate authentication information from the authentication data; and
c. output authentication information for transmission to the relying party
Clause 12—The authenticator of clause 11, in which the authentication data comprises a public credential and private data.
Clause 13—The authenticator of clause 12, in which the public credential and the private data comprise a public-private key pair.
Clause 14—The authenticator of clause 11, in which the circuitry to generate authentication information from the authentication data comprises circuitry to generate a signature.
Clause 15—The authenticator of clause 14, in which the circuitry to generate a signature comprises circuitry to sign data (challenge) associated with the relying party using the authentication data.

Although the above examples have been described with reference to a set of authenticators comprising the initial authenticator 302 and the further authenticator 304, examples are not limited thereto. Examples can be realised in which the set of authenticators comprises N authenticators, where N≥2. In such examples, the operations performed by initial authenticator are performed on behalf of at least a subset, or all, of the other authenticators in the set of authenticators. Similarly, the operations performed by the further authenticator 304 are performed by all such other authenticators, other than the initial authenticator, in the set of authenticators.

It will be appreciated that a signature of the above described signatures is an example of proof of possession of private authentication data that corresponding to an associated public credential.

The above examples have been described with reference to the authenticators registering with the cloud server 306 in advance of storing and retrieving the encrypted authentication data 522. However, examples are not limited to such arrangements. Examples can be realised in which the initial authenticator 302 can deposit with the cloud server 306 the encrypted authentication data 522 together with the corresponding public credential, or other identifier, for the further authenticator 304. Although the example uses the corresponding public credential as an identifier, the public credential is merely one example of possible identifiers. Alternative, or additional, identifiers can comprise, for example, an email address or any other identifier. It will be appreciate that the encrypted authentication data 522 is an example of a ciphertext. The further authenticator 304 can subsequently request from the cloud server 306, without registering, for a copy of all ciphertext linked to the public credential associated with the further authenticator 304. In response, the cloud server can send any such ciphertexts to the further authenticator 304. The further authenticator 304, having received the ciphertexts linked to the further authenticator's public credential, can decipher the ciphertexts and use any recovered authentication data in authenticating to the relying party 308. In such an arrangement, the further authenticator 304 does not have to register with the cloud server 306 in advance of receiving the ciphertext relating to the encrypted authentication data 522.

The above examples have been described with reference to the string or other identifier 510 associated with the relying party 308 being used to distinguish the relying party 308 from other relying parties. Any of the above examples can be arranged to use the string or other identifier 510 to derive the authentication data in a manner rendering the authentication data specific to the relying party 308.

1. Machine readable storage storing instructions arranged, when processed, to facilitate authentication using an authenticator, the instructions comprising instructions to:
a. generate, by an initial authenticator, authentication data associated with a further authenticator; the authentication data comprising private data and a public credential; the public credential and private data being for use in producing authentication information to authenticate the further authenticator to a relying party; and
b. send data derived from the authentication data to network storage commonly accessible by the initial authenticator and the further authenticator.

2. The machine readable storage of claim 1, comprising instructions to: register the public credential with the relying party.

3. The machine readable storage of claim 1, in which the instructions to send data associated with the authentication data to network storage commonly accessible by the initial authenticator and the further authenticator comprises instructions to derive the data associated with the authentication data by processing the authentication data.

4. The machine readable storage of claim 3, comprising instructions to: receive, from the further authenticator, a public key of encryption data associated with the further authenticator.

5. The machine readable storage of claim 4, in which the instructions to encrypt the authentication data comprise instructions to: encrypt the authentication data using the public key.

6. The machine readable storage of claim 1, comprising instructions to: generate, by the initial authenticator, authentication data associated with the initial authenticator; the authentication data comprising private data and a public credential for use in authenticating the initial authenticator to the relying party; and send authentication information, comprising the public credential associated with the initial authenticator and proof of possession of the private data, to the relying party.

7. Machine readable storage storing instructions arranged, when processed, to: access, by a further authenticator (A2), via network storage commonly accessible to an initial authenticator and the further authenticator, data associated with authentication data with the further authenticator for authenticating the further authenticator to a replying party; the authentication data having been generated by the initial authenticator.

8. The machine readable storage of claim 7, comprising instructions to: authenticate the further authenticator to the relying partying using authentication information derived from the accessed authentication data associated with the further authenticator.

9. The machine readable storage of claim 7, comprising instructions to: decrypt the accessed authentication data to use the decrypted authentication data to authenticate the further authenticator to the relying party.

10. The machine readable storage of claim 7, comprising instructions to: send a public key of encryption data associated with the further authenticator to the initial authenticator for use by the initial authenticator in encrypting the authentication data associated with the further authenticator.

11. An authenticator device for authenticating to a relying party; the authenticator device comprising logic or circuitry to:
access authentication data retrieved from network accessible storage; the authentication data having been generated by a different authentication device;
generate authentication information from the authentication data; and
output authentication information for transmission to the relying party,

12. The authenticator of claim 11, in which the authentication data comprises a public credential and private data.

13. The authenticator of claim 12, in which the public credential and the private data comprise a public-private key pair.

14. The authenticator of claim 11, in which the circuitry to generate authentication information from the authentication data comprises circuitry to generate a signature.

15. The authenticator of claim 14, in which the circuitry to generate a signature comprises circuitry to sign data associated with the relying party using the authentication data.
